(19) United States
(12) Patent Application Publication
(10) Pub. No.: US 2016/0309654 A1
(43) Pub. Date: Oct. 27, 2016

(54) AGRICULTURAL RAKE

(71) Applicant: FELLA WERKE GmbH, Hesston, KS (US)

(72) Inventor: Juergen RIEDEL, Feucht (DE)

(21) Appl. No.: 15/104,411

(22) PCT Filed: Dec. 8, 2014
(86) PCT No.: PCT/EP2014/076893

§ 371 Date: Jun. 14, 2016

(30) Foreign Application Priority Data
Dec. 20, 2013 (GB) 1322779.8

(51) Int. Cl. A01D 78/00; A01D 78/10

(52) U.S. Cl. CPC A01D 78/007; A01D 78/1014; A01D 78/105

(57) ABSTRACT

An agricultural rake including a frame, ground engaging wheels for supporting the frame on the ground, and at least two rotors each of which is driven in rotation about a respective vertical rotor axis and mounted to the frame by a folding linkage that permits folding movement of each rotor between a working position and a raised position. Each rotor has at least one ground engaging guide wheel mounted inwardly of crop engaging tines with a height adjustment mechanism permitting adjustment of the rotor operating height. For road transport, a control system automatically retracts each ground engaging guide wheel into the respective rotor in the raised position to reduce overall width.

The invention relates to agricultural forage windrowers and particularly rakes with two or more rotors that rotate about respective vertical axes and support a plurality of tines.

Agricultural rakes generally comprise a frame, ground engaging wheels for supporting the frame on the ground, and at least one rotor which is driven in rotation about a vertical rotor axis. In use the frame is attached to the rear of an agricultural tractor by means of a drawbar and towing hitch for example. A torque is transferred from a power take-off (PTO) stub on the tractor to the rotors by a drive train.

Each rotor comprises a hub and a plurality of tine arms extending radially from the hub. Crop engaging tines are attached to the radially outermost ends of the arms for raking or windrowing cut forage material laying on the ground. To engage and release the crop material, the tines are respectively lowered and raised at predetermined positions around the rotary circumferential path. To effect this lowering and raising the innermost end of each tine arm is slideably engaged in a cam track. As the rotor rotates rollers on the arms move along the circular cam track which serves to twists the tine arms on their respective axes, thus raising and lowering the tines. Such an arrangement is present on rakes marketed by the applicant today under the brand “Fella”, including model TS9060.

The working height of a rotor above ground is maintained by a rotor running gear comprised of one or more support wheels mounted below the hub. The support wheels protrude below the lowest position of tine to prevent the tines from striking the ground, which could otherwise result in damage to the tines and/or soil contamination of the forage material. The optimum working height may vary depending on factors such as the type of forage material and underlying terrain, and it is known to provide a height adjustment mechanism to extend or retract the support wheels relative to the hub. Such a mechanism may comprise a simple manually operated mechanical lever, or a more complex electrical or hydraulic actuator arrangement that may be adjusted from the tractor cab.

Various rotor configurations are available on the market ranging from single-rotor rakes to four-rotor rakes which have an operating width in excess of 12 metres. It is known to exploit a folding mechanism to provide a headland mode in which the rotors are partially folded upwards when making turns on the headland. Advantageously, this reduces the width of the machine temporarily thus reducing the space required to make the turn. Most models further include a transport mode in which the rotors fold into an upright position thus reducing the overall width of the machine. This is a particular issue for road transport: many countries have statutory limits on the width of implements that may be towed on the open road without requiring additional escort vehicles or police accompaniment. In the United Kingdom, the unescorted width limit is 3.0 m.

It is an object of the invention to provide an improved control system for an agricultural rake.

In accordance with a first aspect of the invention there is provided an agricultural rake comprising a frame, ground engaging wheels for supporting the frame on the ground, and at least two rotors each of which is driven in rotation about a respective vertical rotor axis and mounted to the frame by a folding linkage that permits folding movement of each rotor between a working position and a raised position around a longitudinal axis;

each rotor comprising a hub, a plurality of tine arms extending substantially radially from the hub and having crop engaging tines attached to the radially outermost ends thereof, and a rotor running gear comprising at least one ground engaging guide wheel mounted inwardly of the tines below the hub to a height adjustment mechanism;

the rake further comprising a control system coupled with each height adjustment mechanism and arranged to automatically retract each ground engaging guide wheel towards its respective hub when the respective rotor is moved to the raised position.

Also in accordance with the present invention there is provided a method of operating an agricultural rake having at least two rotors each of which is driven in rotation about a respective vertical rotor axis and mounted to a frame by a folding linkage that permits folding movement of each rotor between a working position and a raised position around a longitudinal axis;

wherein each rotor comprises a hub, a plurality of tine arms extending substantially radially from the hub with crop engaging tines attached to the radially outermost ends thereof, and a rotor running gear comprising at least one ground engaging guide wheel mounted inwardly of the tines below the hub to a height adjustment mechanism;

the method comprising automatically retracting each ground engaging guide wheel towards its respective hub when the respective rotor is moved to the raised position.

Wth the ground engaging wheels retracted, preferably to a position within the cylindrical space bounded by the tines, the outside width of the rake is reduced. This is of benefit especially for larger rakes which may otherwise struggle to comply with unescorted width limitations. For smaller rakes the retraction enables greater separation of the raised rotors, giving greater space available between for the mounting of hubs and linkages to raise the rotors.

The hydraulic circuit may be configured to position the rotor in one of a plurality of pre-set positions including the working position, a headland position and a transport position, and may suitably be arranged to retract the ground engaging wheels when entering a transport position but not to do so for a headland.

Embodiments of the invention will now be described, by way of example only, and with reference to the appended drawings in which:

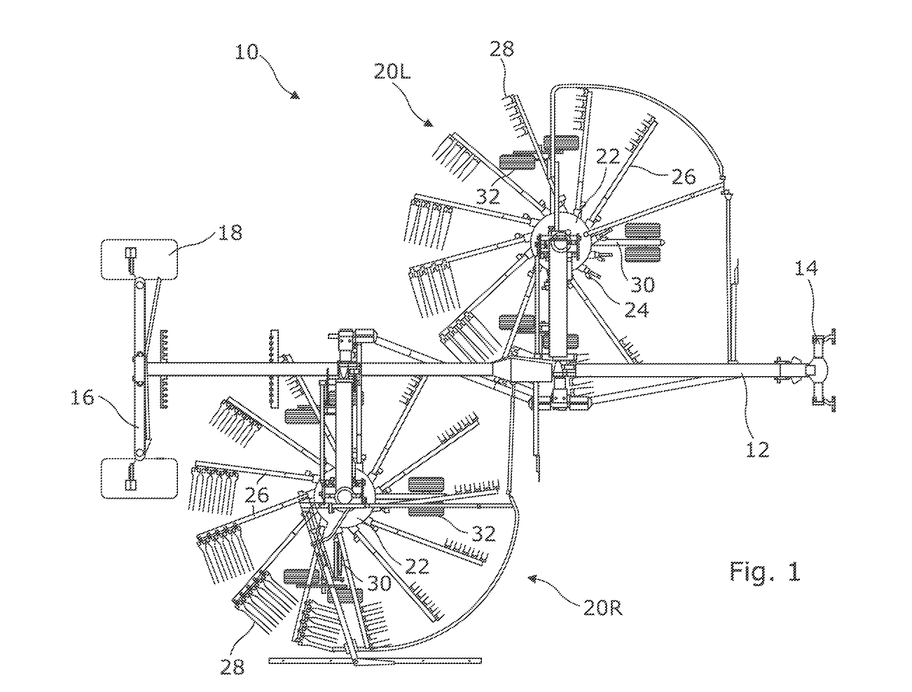

FIG. 1 is a plan view of a twin rotor agricultural rake;

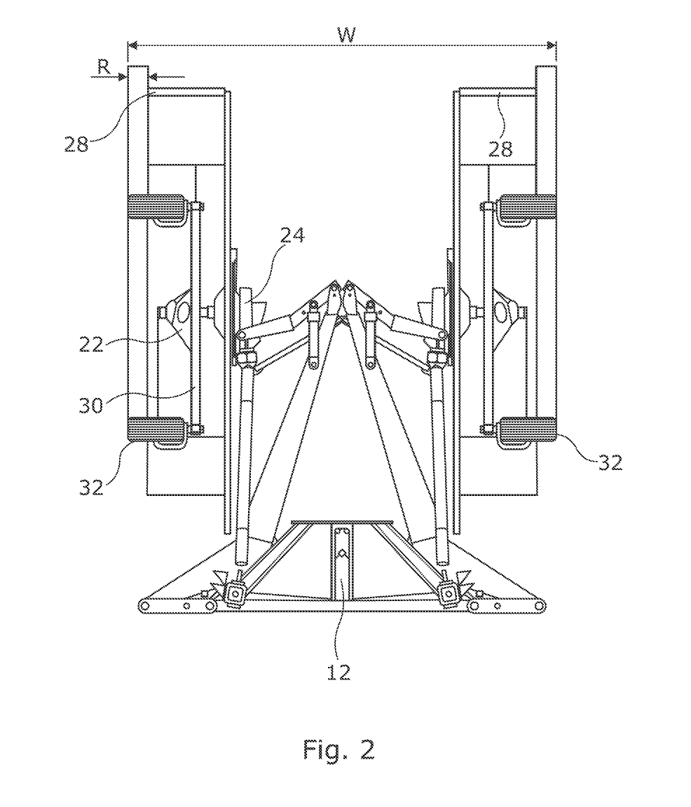

FIG. 2 is an end view of an agricultural rake with rotors raised and rotor ground engaging wheels in an operating position;

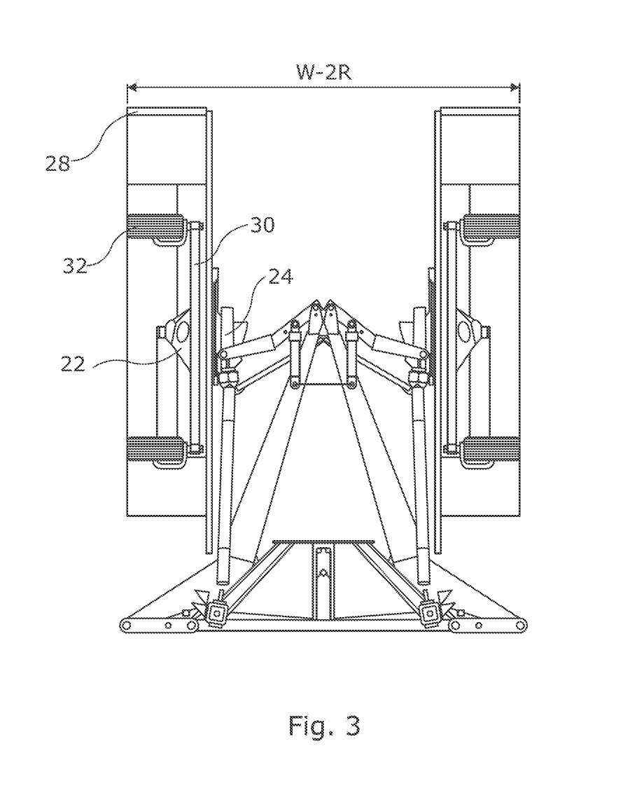

FIG. 3 shows the rake of FIG. 2 with the rotor ground engaging wheels retracted to a transport position; and

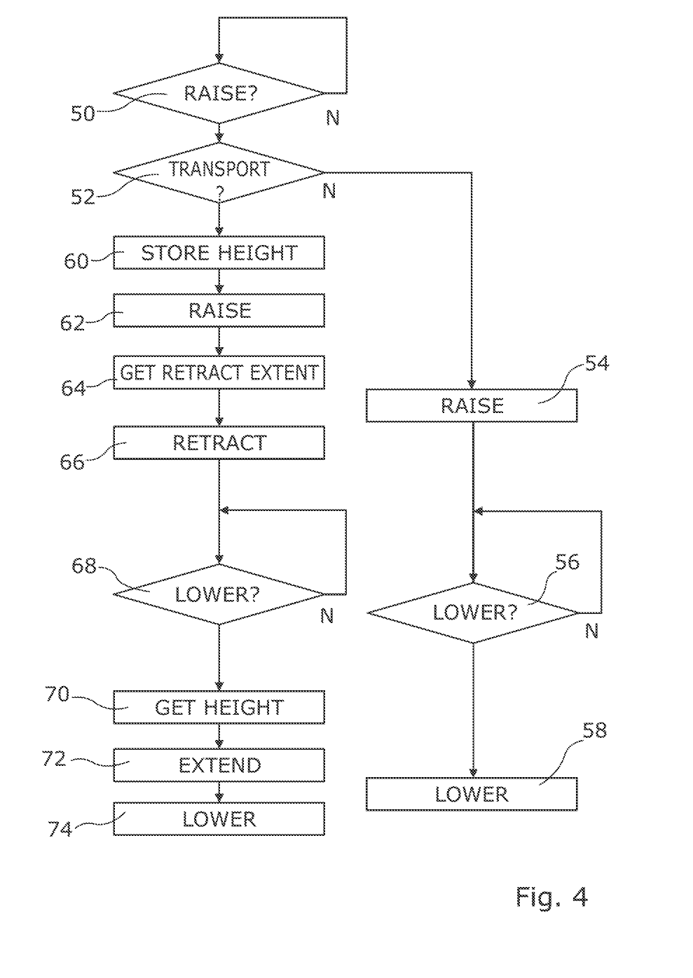

FIG. 4 is a flow chart representation of a method of operating the rake of FIGS. 2 and 3.

With reference to FIG. 1, a twin rotor rake 10 comprises a frame 12 running from front to rear. At the front end of frame 12 a mounting linkage 14 is provided for hitching the rake 10 to the lower links of a tractor three-point linkage (not shown). At the rear end an axle 16 with steerable wheels 18 is pivotally attached to the frame 12.

The rake 10 comprises a pair of working tools in the form of rotors, supported on frame 12 and designated generally at 20L (left-hand rotor) and 20R (right-hand rotor) and which are offset in a fore and aft direction and each define a raking circle that overlaps the longitudinal part of frame 12 . The left-hand rotor 20L comprises a hub 22 mounted to the underside of a gearbox 24 for rotation around a vertical axis. Thirteen tine arms 26 are mounted to, and extend radially from, the hub 22. Crop engaging tines 28 are attached to the outermost ends of each tine arm 26. For clarity, three tines arms and tines are omitted from the left-hand rotor 20L shown in FIG. 1. Furthermore, it should be appreciated that more or less tine arms can be employed.

For each rotor 20L, 20R, a rotor running gear includes one or more connected beams 30 carrying ground engaging guide wheels 32 mounted to the underside of the rotor to provide support when travelling across the field during operation. Each hub 22 comprises an electrical or hydraulically actuated mechanism arranged to extend the running gear away from the hub, thereby raising the effective operating height of the rotor relative to the ground, and to retract the running gear towards the hub, lowering the rotor.

FIGS. 2 and 3 show the rotors 20L, 20R in a raised position: the axle 16 and steerable wheels 18 are omitted for the sake of clarity. In FIG. 2, the ground engaging guide wheels 32 are not retracted, giving an overall width for the rake of W. In FIG. 3, the ground engaging wheels 32 have been retracted under control of a control system 34 by an amount R such as to bring them level with the lowest tine position and thus within the generally cylindrical area bounded by the hub tines. With the retraction, the overall width of the rake is reduced to W−2R. Whilst the overall width W may be acceptable for headland manoeuvres in a field, the reduced width due to retraction may enable the rake to meet the prescribed requirement permitting unescorted road travel thereby reducing manpower and associated costs to the user.

FIG. 4 represents a number of fixed and optional steps for operating the rake of FIG. 3, which steps are implemented under the direction of the control system 34. In the first step 50, a “raise” command is watched for. Following this, at step 52, a determination is made as to whether the rotors are to be lifted to a road transport position, or are to be raised for some other purpose, such as a headland turn.

If the rotors are not to be raised for road transport, then at step 54 they are raised without retraction of the ground engaging wheels. At step 56, a “lower” command is watched for and, when received, at step 58 the rotors are lowered to operating position resting on the ground engaging wheels.

If the rotors are to be raised for road transport then following step 52 a first optional step 60 may be performed in which the current height setting of the ground engaging wheels is stored, suitably in a memory device associated with the control system. This will be accessed later in step 70 (described below).

At step 62, the rotors are raised to the road transport position. During, or following, the raising, at step 66 the ground engaging wheels are retracted to a position within the area bounded by the tines. Where different extents of retraction are provided for (for example not wholly within the area bounded by the tines but still sufficient to result in a transport width for the rake within permitted limits for unescorted road travel) then an optional step 64 of identifying the desired retraction extent is performed prior to retraction.

At step 68, a “lower” command is watched for. When received, the ground engaging wheels are extended at step 72 and the rotors are lowered at step 74.

Where the optional step 60 has previously been performed, then prior to extending the stored height of the ground engaging wheels is accessed from storage and applied during extension step 72 such that the rotors are returned to their last operating height.

As will be recognised, further variations are possible to the above described method of operation. For example, where the tractor towing the rake is provided with a partially or fully automated guidance system which guides the tractors path in a field, the start and end of a headland manoeuvre may be identified by the guidance system and the steps of raising (step 54) and lowering (step 58) being triggered accordingly. Furthermore, in such an arrangement the guidance system may determine when manoeuvres in a field are completed and automatically trigger the raising to the road transport position and retraction of the ground engaging wheels.

The control system coordinating the raising with retraction and lowering with extension may be fully integrated with implement control and/or guidance systems of the towing tractor, or it may be at least partly provided on the rake itself, suitably coupled with the tractor via an ISOBUS or similar connection. In a far simpler implementation, with corresponding cost reduction, the control system may be provided by a simple sequence control or even a simple mechanical linkage arrangement causing the ground engaging wheels to retract whenever a rotor is raised.

1. An agricultural rake comprising:
a frame;
ground engaging wheels for supporting the frame on the ground;
at least two rotors each of which is driven in rotation about a respective vertical rotor axis and mounted to the frame by a folding linkage that permits folding movement of each rotor between a working position and a raised position around a longitudinal axis, each rotor comprising:
a hub;
a plurality of tine arms extending substantially radially from the hub and having crop engaging tines attached to the radially outermost ends thereof; and
a rotor running gear comprising at least one ground engaging guide wheel mounted inwardly of the tines below the hub to a height adjustment mechanism; and
a control system coupled with each height adjustment mechanism and arranged to automatically retract each ground engaging guide wheel towards its respective hub when the respective rotor is moved to the raised position.

2. The agricultural rake as claimed in claim 1, wherein the control system is arranged to automatically retract each ground engaging guide wheel towards its respective hub by an extent such as to bring each guide wheel to within an area bounded by the tines of the respective hub.

3. The agricultural rake as claimed in claim 1, wherein the control system is arranged to automatically retract each ground engaging guide wheel towards its respective hub by an extent such as to result in a predetermined width for the rake with the hubs in the raised position.

4. The agricultural rake as claimed in claim 1, wherein the control system is further arranged to reverse the extent of retraction when the hubs are returned from the raised to the working position.

5. The agricultural rake as claimed in claim 1, wherein each height adjustment mechanism includes a hydraulic cylinder and the control system is configured to control the extent of extension and contraction thereof.

6. The agricultural rake as claimed in claim 1, wherein each height adjustment mechanism includes an electric motor and a mechanism for converting the rotation thereof to extension and retraction of an attached guide wheel under control of the control system.

7. A method of operating an agricultural rake having at least two rotors each of which is driven in rotation about a respective vertical rotor axis and mounted to a frame by a folding linkage that permits folding movement of each rotor between a working position and a raised position around a longitudinal axis, wherein each rotor comprises a hub, a plurality of tine arms extending substantially radially from the hub with crop engaging tines attached to the radially outermost ends thereof, and a rotor running gear comprising at least one ground engaging guide wheel mounted inwardly of the tines below the hub to a height adjustment mechanism; the method comprising:
automatically retracting each ground engaging guide wheel towards its respective hub when the respective rotor is moved to the raised position.

8. The method as claimed in claim 7, wherein the step of automatically retracting each ground engaging guide wheel towards its respective hub when the respective rotor is moved to the raised position comprises retracting by an extent such as to bring each guide wheel to within an area bounded by the tines of the respective hub.

9. The method as claimed in claim 7, wherein the step of automatically retracting each ground engaging guide wheel towards its respective hub when the respective rotor is moved to the raised position comprises retracting by an extent such as to result in a predetermined width for the rake with the hubs in the raised position.

10. The method as claimed in claim 7, further comprising reversing the extent of retraction when the hubs are returned from the raised to the working position.

11. The method as claimed in claim 7, wherein two raised positions are defined, one for road transport of the rake and one for performing headland manoeuvres in a field, and wherein the retraction of guide wheels is not performed during headland manoeuvres.
